(19) United States
(12) Patent Application Publication
(10) Pub. No.: US 2002/0172789 A1
(43) Pub. Date: Nov. 21, 2002

(54) Electrically conductive polymeric housing for process control equipment

(76) Inventors: Ian George Watson, Fraserville (CA); Ronald Gregory Hare, Peterborough (CA)

Correspondence Address: BIRCH STEWART KOLASCH & BIRCH, PO BOX 747, FALLS CHURCH, VA, 22040-0747, US

(21) Appl. No.: 09/858,601

(22) Filed: May 17, 2001

(51) Int. Cl. B32B 1/08

(52) U.S. Cl. 428/36.91

(57) ABSTRACT

An electrically conductive polymeric housing or enclosure for process control equipment. The enclosure comprises a moldable thermoplastic polymer and carbon nanotubes. The carbon nanotubes are generally uniformly dispersed within said moldable thermoplastic polymer, such that the surface resistivity of the housing is less than 10⁹ Ohms for Level 1 compliance.

### FIELD OF THE INVENTION

The present invention relates to process control equipment, and more particularly to an electrically conductive polymeric housing for process control equipment.

### BACKGROUND OF THE INVENTION

In 1994, the European Union (EU) adopted the ATEX Directive 94/9/EC, which establishes the technical and legal requirements for products intended for use in potentially explosive environments. Compliance with the Directive becomes mandatory for all subject products within the EU as of Jul. 1, 2003. Any product placed on the market or put into use in hazardous environments governed by the Directive is required to meet the standards set out in the Directive. The standards vary depending on the classification of the hazardous area. The Directive describes three levels of escalating explosion potential within either “gas” or “dust” hazard environments. The levels are classified as 1, 2 or 3, with Level 1 being the most hazardous level.

One of the standards for equipment in hazardous areas requires that polymer housings containing electrical equipment be electrically conductive. Specifically, polymer housings for use within Level 1 hazardous areas must have a surface resistivity of less than 10⁹ Ohms. The concern that the Directive is addressing is the potential build up of static charges within the polymer housing. If a sufficient static charge is built up, then there is the potential for a spark, which in a gaseous or dusty environment presents a significant risk of explosion or fire.

In addition to the compliance issue raised by the Directive and the potential for static charge build-up, the low conductivity of polymer housings presents a problem for containing electromagnetic radiation produced by electronic circuitry contained within the housings. The radiation can cause unwanted interference with equipment outside the housing. As a result, attempts have previously been made to increase the electrical conductivity of polymer housings in order to contain electromagnetic radiation.

Most thermoplastic polymers have a surface resistivity in the range of 10¹³ to 10¹⁶ Ohms. There are some well-known methods of reducing the surface resistivity of thermoplastic polymers. These methods involve dispersing an electrically conductive material within the polymer. Electrically conductive materials typically used to reduce the resistivity of polymer housings include aluminum filaments or carbon black. These materials, in sufficient quantity, can dramatically reduce the resistivity of the polymer housing.

The polymers used to form electrical housings for equipment used in hazardous areas are carefully chosen for their physical properties. Among the important properties are chemical resistance, cold impact strength, flame retardance and toughness. The typical polymers that are most often used include polypropylene; Kynar®, a polyvinylidene flouride; and Tefzel®, a flouropolymer resin.

There are, however, significant drawbacks to the use of carbon black or aluminum filaments. These additives negatively impact the mechanical properties of the polymer, usually adding substantial stiffness and lowering the impact strength of an article constructed using the polymer. In addition, the additives have a dramatic impact on the melt index, a measure of the viscosity of the polymer. The melt index is an important property that indicates the ease with which a polymer can be poured into a mould. In some cases, additives like carbon black can lower the melt index of a polymer by a factor of 10.

Considering the standards imposed by the Directive, the need to prevent static charge build-up and the problem of containing electromagnetic radiation, there remains a need for an electrically conductive polymeric housing for electrical equipment that does not sacrifice the advantageous physical properties of traditional polymeric housings, while providing the requisite electrical conductivity properties.

### BRIEF SUMMARY OF THE INVENTION

Accordingly, the present invention comprises an electrically conductive polymeric housing for electronic equipment that is constructed of a moldable polymer that contains a dispersion of carbon nanotubes sufficient to make the surface resistivity of the housing less than 10⁹ Ohms for Level 1 compliance.

In a first aspect, the present invention provides an electrically conductive polymeric housing for process control equipment including a moldable thermoplastic polymer and carbon nanotubes dispersed within the moldable thermoplastic polymer, such that the surface resistivity of the housing is in the range of 10⁹ Ohms.

In a second aspect, the present invention provides a level detection apparatus including an electrically conductive polymeric housing comprising a moldable thermoplastic polymer and carbon nanotubes dispersed within the moldable thermoplastic polymer, and the electrically conductive polymeric housing having a surface resistivity which is less than 10⁹ Ohms, a transducer mounted within the housing adapted to send a signal and receive a reflected signal, and an electronic circuit coupled to the transducer, and the electronic circuit controls the transducer and processes the reflected signal.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Reference will now be made, by way of example, to the accompanying drawings which show a preferred embodiment of the present invention, and in which:

FIG. 1 shows a perspective view of an electrically conductive polymer housing according to the present invention; and

FIG. 2 is a schematic diagram of a level measurement device utilizing an electrically conductive polymeric housing according to the present invention.

### DETAILED DESCRIPTION OF THE INVENTION

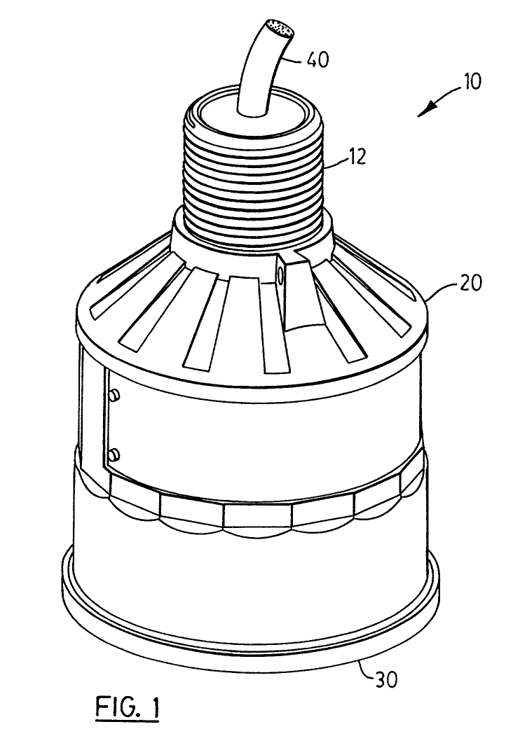

Reference is first made to FIG. 1 which shows a level measuring device indicated generally by reference 10. The level measuring device 10 provides non-contactive measurement, and is utilized to determine the distance to a reflective surface, such as the liquid level in a storage tank, by transmitting a signal and measuring the time for the signal to return. The level measuring device 10 may utilize ultrasonic pulses, capacitive signals or microwave signals. The level measurement device 10 finds application in a wide variety of process control situations and in various industries, such as the petroleum industry, water treatment, storage, and chemical industries.

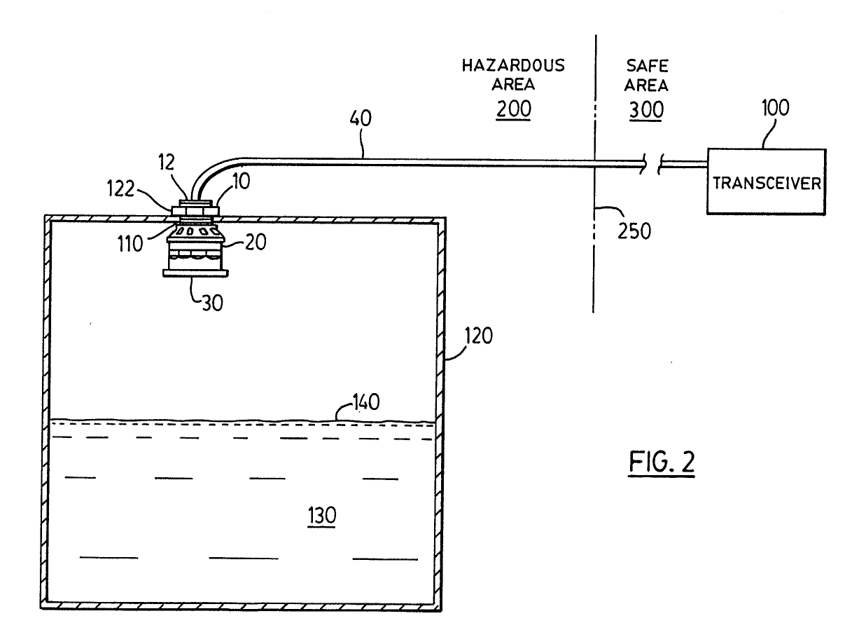

The level measurement device 10 shown in FIG. 1 comprises an ultrasonic transducer and includes a housing 20 with an emitter face 30. The ultrasonic transducer 10 is coupled to a transceiver 100 (FIG. 2) through a conductor 40. The conductor 40 may comprise a two wire arrangement which provides a link for receiving transmit pulses from the transceiver 100, and a link for transmitting receive (i.e. echo) pulses to the transceiver 100. The transducer 10 includes additional circuitry and elements, e.g. piezoelectric elements, and transformer (not shown), for generating the ultrasonic pulses and receiving the reflected pulses. The transceiver 100 includes electronic and programmable controlled circuitry for processing the echo signals and determining the level measurements, which techniques will be familiar to those skilled in the art, and as such are not part of the present invention.

As shown in FIG. 2, the ultrasonic transducer 10 is mounted on an aperture 110 in the top of a storage tank 120. The storage tank holds a material 130 having a level defined by a top surface indicated by reference 140. The surface 140 of the material 130 serves to reflect the ultrasonic energy which is emitted by the transducer 10. The ultrasonic transducer 10 may include a threaded collar 12 which is secured to the tank 120 by a nut 122 or other suitable fastener. Ultrasonic energy pulses are generated by the transducer 10 and transmitted through the emitter face 30 (e.g. a sealed rubber or stainless steel surface) towards the surface 140 of the material 130 contained inside the storage tank 120. Reflected pulses from the surface 140 are sensed by the transducer 10 and transmitted to the transceiver 100 for further processing and to determine the level of the material 130 in the tank 120 by measuring the distance to the reflective surface 140.

The housing or enclosure 20 for the ultrasonic transducer 10 is preferably formed from a chemically resistant material such as Kynar™. When used in hazardous areas, such as in many petroleum industry applications, the ultrasonic transducer 10 or level measurement device must meet strict safety standards. In particular, the housing or enclosure 20 must not permit static charge to build up. In accordance with this aspect of the invention, the housing 10 comprises a polyvinylidene flouride, Kynar®, and a dispersion of carbon nanotubes. The carbon nanotubes reduce the surface resistivity of the housing 10. With the reduced surface resistivity, the housing 20 provides a path to ground that prevents the build up of significant static charges and reduces the possibility of sparking. The surface resistivity of the housing 20 should be in the range of 10⁹ Ohms, and preferably less than 10⁹ Ohms for Level 1 Compliance.

Advantageously, the small size of the nanotubes, which typically have a diameter of 10 to 20 nm, and their high aspect ratio, which can range from 5 to 1000, reduces the percentage by weight of the additive necessary to achieve the desired conductivity in the polymer. The reduced amount of additive necessary results in a lesser impact upon the desirable properties of the polymer. The nanotubes have almost no impact upon the strength and flexibility of the polymers and a less significant impact upon the melt index of the polymers. For instance, the melt index of Kynar®, which is normally 21, is reduced by a factor of about three, to 6.5, when prepared with a carbon nantotubes additive.

Referring to FIG. 2, the installation for storage tank 120 and the transducer 10 may comprise a hazardous area 200 so designated because of the risk of explosion due to sparking. The transceiver 100 is located in a safe area 300 which is separated through an appropriate safety barrier 250. If static, charge were to build up on the housing 20 for the transducer 10, there is a possibility that the charge could arc causing a spark that may ignite any gases or dust in the surrounding environment. However, because the transducer 10 with the housing 20 according to the invention comprises a polymer with a dispersion of carbon nanotubes, the housing 20 has a reduced surface resistivity allowing any surface static charge to be dissipated through the storage tank 120 to ground, reducing the risk of sparking and explosion.

While the present invention is described as a polymeric housing for process control equipment in the context of use in a hazardous area, the present invention has application to housing alternative kinds of equipment and to use in alternative areas. The range of equipment that may be housed and contexts in which the present invention may be used will be obvious to those skilled in the art. Additionally, different configurations of the level measurement device 10 and the enclosure or housing 20 and the internal components of the level measuring system will be understood by those skilled in the art.

The present invention may be embodied in other specific forms without departing from the spirit or essential characteristics thereof. Certain adaptations and modifications of the invention will be obvious to those skilled in the art. Therefore, the above-discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. An electrically conductive polymeric housing for process control equipment comprising:
(a) a moldable thermoplastic polymer, and
(b) carbon nanotubes dispersed within said moldable thermoplastic polymer, and said electrically conductive polymeric housing having a surface resistivity in the range of 10⁹ Ohms.

2. The electrically conductive polymeric housing as claimed in claim1, wherein said carbon nanotubes are generally uniformly dispersed and said moldable thermoplastic polymer comprises polypropylene.

3. The electrically conductive polymeric housing as claimed in claim1, wherein said carbon nanotubes are generally uniformly dispersed and said moldable thermoplastic polymer comprises flouropolymer resin.

4. The electrically conductive polymeric housing as claimed in claim 1, wherein said carbon nanotubes are generally uniformly dispersed and said moldable thermoplastic polymer comprises polyvinyldene flouride.

5. The electrically conductive polymeric housing as claimed in claim 1, 2, 3 or 4, wherein said moldable thermoplastic polymer and said carbon nanotubes, together, have a melt index of at least 6.5.

6. A level measurement apparatus for measuring the level of a material contained in a storage container, said level measurement apparatus comprising:
(a) an electrically conductive polymeric housing comprising a moldable thermoplastic polymer and carbon nanotubes dispersed within said moldable thermoplastic polymer, and said electrically conductive polymeric housing having a surface resistivity less than 10⁹ Ohms;
(b) a transducer mounted within said housing adapted to emit a signal and receive a reflected signal; and
(c) a communication link coupled to said transducer for receiving and transmitting signals to a transceiver, and said transceiver including an electronic circuit for processing signals received from said transducer for determining the level of the material contained in the storage container.

7. The level measurement apparatus as claimed in claim 6, wherein said carbon nanotubes are generally uniformly dispersed and said moldable thermoplastic polymer comprises polypropylene.

8. The level measurement apparatus as claimed in claim 6, wherein said carbon nanotubes are generally uniformly dispersed and said moldable thermoplastic polymer comprises flouropolymer resin.

9. The level measurement apparatus as claimed in claim 6, wherein said carbon nanotubes are generally uniformly dispersed and said moldable thermoplastic polymer comprises polyvinylidene flouride.

10. The level measurement apparatus as claimed in claim 6, 7, 8 or 9, wherein said electrically conductive polymeric housing has a melt index of at least 6.5.
